(19) United States
(12) Patent Application Publication
(10) Pub. No.: US 2025/0252863 A1
(43) Pub. Date: Aug. 7, 2025

(54) AI-GENERATED ESSAY FEEDBACK FOR ASSISTING TUTORS

(71) Applicant: Paper Education Company Inc., Montreal (CA)

(72) Inventors: Rachel Hantz, Montreal (CA); Charlotte Richardson, Montreal (CA); Ashkan Golzar, Montreal (CA)

(73) Assignee: Paper Education Company Inc., Montreal, QC (CA)

(21) Appl. No.: 18/589,679

(22) Filed: Feb. 28, 2024

(30) Foreign Application Priority Data
Feb. 2, 2024 (CA) 3228023

(51) Int. Cl. G09B 5/02

(52) U.S. Cl. CPC G09B 5/02

(57) ABSTRACT

A non-transitory computer-readable medium stores code which when executed by one or more processors of one or more computing devices causes the one or more computing devices to assist a human tutor to assess an essay written by a student by analyzing the essay using a Large Language Model (LLM) to output AI-generated suggested written corrective feedback to the human tutor via a user interface to enable human-in-the-loop (HITL) review of the AI-generated suggested written corrective feedback. Input is received from the human tutor via the user interface to accept, reject or edit the AI-generated suggested written corrective feedback to thereby constitute HITL-AI written corrective feedback. The HITL-AI written corrective feedback is communicated to the student.

### CROSS-REFERENCE TO RELATED APPLICATIONS

This application claims the benefit of Canadian Patent Application No. 3,228,023, filed Feb. 2, 2024, the disclosure of which is incorporated herein by reference in its entirety.

### TECHNICAL FIELD

The present invention relates generally to computerized systems, methods and computer-readable media (i.e. software) for providing feedback to students on their essays and, more particularly, to AI-generated feedback to assist human tutors in providing students with feedback on their essays.

### BACKGROUND

Tutoring students to write essays has traditionally been a labour-intensive task, requiring skilled human tutors to review student essays and to provide written feedback (i.e. comments) to the students to help them improve their essay writing skills. The comments may relate to grammar, spelling, syntax, style, clarity, structure, persuasiveness or any other aspect of essay writing. One challenge in tutoring students is to provide timely feedback. Another challenge is to ensure that the feedback strikes the right tone, is useful and constructive. Providing timely, encouraging and constructive feedback to students in an efficient manner is highly desirable for student learning. A technical solution that provides such feedback in an efficient manner would thus be highly desirable.

### SUMMARY

In general, the present invention provides a computerized system, computer-implemented method and computer-readable medium to generate feedback on an essay written by a student for a tutor to use in providing comments to the student. The AI-generated suggested written feedback is reviewed by the human tutor, thus providing human-in-the-loop (HITL) oversight of the AI-generated suggested written feedback.

One aspect of the disclosure is a non-transitory computer-readable medium that stores code. The code of this computer-readable medium, when executed by one or more processors of one or more computing devices, causes the one or more computing devices to assist a human tutor to assess an essay written by a student by analyzing the essay using a Large Language Model (LLM) to output AI-generated suggested written corrective feedback to the human tutor. This enables human-in-the-loop (HITL) review of the AI-generated suggested written corrective feedback. Input is received from the human tutor to accept, reject or edit the AI-generated suggested written corrective feedback to thereby constitute HITL-AI written corrective feedback, which is then communicated to the student. HITL-AI written feedback constitutes AI-generated feedback that has been reviewed and approved by human tutors, supplemented with comments written exclusively by tutors.

Another aspect of the disclosure is a computer-implemented method of assisting a human tutor in tutoring a student in writing an essay. The method entails analyzing the essay using a Large Language Model (LLM) to output AI-generated suggested written corrective feedback to the human tutor to enable human-in-the-loop (HITL) review of the AI-generated suggested written corrective feedback. The method further entails receiving input from the human tutor to accept, reject or edit the AI-generated suggested written corrective feedback to thereby constitute HITL-AI written corrective feedback. The method also entails communicating the HITL-AI written corrective feedback to the student.

Yet another aspect of the disclosure is a computer system for assisting a human tutor to assess an essay written by a student. The system includes a tutor computing device for the human tutor to view the essay. The system also includes one or more tutoring platform servers for receiving the essay from the student and for transmitting the essay to the tutor computing device. A Large Language Model (LLM) server hosts a Large Language Model, the LLM server receiving one or more prompts from the one or more tutoring platform servers to cause the LLM to analyze the essay and to output AI-generated suggested written corrective feedback to the one or more tutoring platform servers and tutor computing device for viewing by the human tutor. This enables human-in-the-loop (HITL) review of the AI-generated suggested written corrective feedback by the human tutor. The tutor computing device receives input from the human tutor to accept, reject or edit the AI-generated suggested written corrective feedback to thereby constitute HITL-AI written corrective feedback. The tutor computing device communicates the HITL-AI written corrective feedback to the one or more tutoring platform servers and then the one or more tutoring platform servers communicate the HITL-AI written corrective feedback to the student.

The foregoing presents a simplified summary of the invention in order to provide a basic understanding of some aspects of the invention. This summary is not an exhaustive overview of the invention. It is not intended to identify essential, key or critical elements of the invention or to delineate the scope of the invention. Its sole purpose is to present some concepts in a simplified form as a prelude to the more detailed description that is discussed later. Other aspects of the invention are described below in relation to the accompanying drawings.

### BRIEF DESCRIPTION OF THE DRAWINGS

Further features and advantages of the present technology will become apparent from the following detailed description, taken in combination with the appended drawings, in which:

FIG. 1 schematically depicts a computer system that creates AI-generated feedback to assist a tutor in tutoring a student in essay writing in accordance with an embodiment of the present invention;

FIG. 2 depicts an example of a user interface of a computing device enabling a tutor to review AI-generated feedback;

FIG. 3 depicts a flowchart of a method of assisting a tutor in providing feedback to a student in accordance with an embodiment of the present invention;

FIG. 4 depicts a flowchart of a method of classifying AI-generated comments and optionally tuning prompts for interacting with a large language model in order to elicit AI-generated feedback that aligns with rubric dimensions;

It will be noted that throughout the appended drawings, like features are identified by like reference numerals.

### DETAILED DESCRIPTION

In general, the exemplary embodiments disclosed in this specification provide a computerized system, computer-implemented method and computer-readable medium to generate feedback on an essay written by a student for a tutor to use in providing comments to the student. The AI-generated suggested written feedback is reviewed by the human tutor, thus providing human-in-the-loop (HITL) oversight of the AI-generated suggested written feedback.

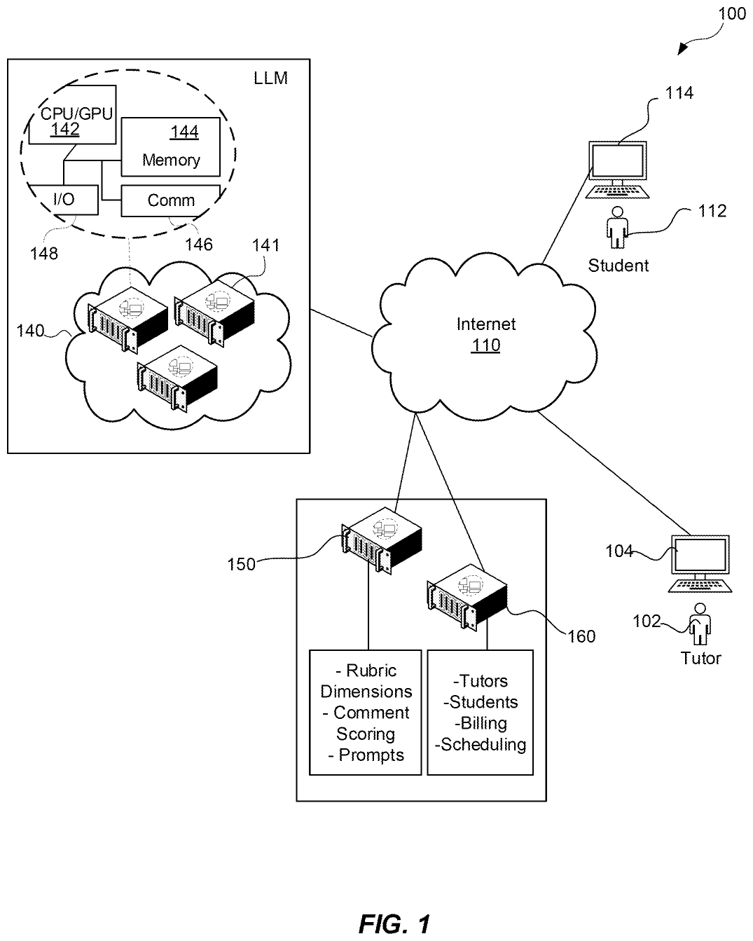

FIG. 1 depicts an example computer system for assisting a human tutor to assess an essay written by a student in accordance with an embodiment of the present invention. The example computer system is generally denoted by reference numeral 100. The computer system is designed to enable a tutor 102 to provide essay writing feedback to a student 112. It will be appreciated that the system may include multiple tutors 102 and multiple students 112 in any suitable or desired ratio. For example, a single tutor may be tutoring multiple students. For the purposes of this specification, the term “tutor” shall be interpreted broadly to encompass a teacher, professor, instructor, mentor, teaching assistant, coach, or any person who is training, teaching or tutoring a student. Likewise, for the purposes of this specification, the term “student” shall be interpreted broadly to encompass a kindergarten student, grade school or high school student (K-12) as well as a college student, university student or any other person who is learning or studying. For the purposes of this specification, the term “essay” shall be interpreted broadly to encompass any written or textual work or composition, such as an essay, short story, poem, article, book report, science project, humanities project, etc.

As shown by way of example in FIG. 1, the computer system 100 includes a tutor computing device 104, a student computing device 114, and one or more tutoring platform servers 150, all of which are connected to the internet 110 via suitable network interface cards, network interface controllers, adapters, modems, routers, or data communication ports. The tutor computing device 104 and the student computing device 114 each includes a processor, a memory coupled to the processor, and a user interface having a display screen and keyboard (or virtual keyboard) for essay writing and review. The computing devices 104, 114 may be desktop computers, laptop computers, tablets, smart phones or any other similar device on which a user can compose an essay and/or review an essay.

In the computer system 100 shown by way of example in FIG. 1, the human tutor 102 interacts with the tutor computing device 104 to view the essay, to review AI-generated feedback and to accept, reject or edit (modify) the AI-generated feedback, or to add a new comment, as will be explained in greater detail below. In the computer system 100 shown by way of example in FIG. 1, the student 112 interacts with the student computing device 114 to compose the essay and to transmit the essay to the one or more tutoring platform servers 150, 160 via the internet 110. As depicted by way of example in FIG. 1, the one or more tutoring platform servers 150, 160 includes an optional tutor management server which may be integrated with or separate from the other servers of the one or more tutoring platform servers 150, 160. The tutor management server may optionally be used to store and manage a list of tutors, their profiles, competencies, contracts, availabilities, wages, etc. The tutor management server may also optionally store student information, including student names, skills, ages, competencies, learning profiles, etc. The tutor management server may also optionally include a billing module for billing students, schools, school boards, or their parents, as the case may be, for the tutoring services and a scheduling module for coordinating students and tutors, e.g. matching available tutors with students. The servers 150, 160 may optionally be amalgamated into a single server or the various services and functions described above may be distributed over multiple servers. It will be appreciated that the servers 150, 160 may be part of a server cluster, server farm or a cloud service. It will be appreciated that the features, modules or components mentioned for servers 150, 160 are only examples and furthermore it will be appreciated that these features, modules or components of servers 150, 160 may be performed by other machines or servers.

In the embodiment of FIG. 1, the one or more tutoring platform servers 150, 160 interact via the internet 110 with a Large Language Model (LLM) server 140. The LLM server may be a cloud-based server 140 or it may be composed of a plurality of servers 141, each having a CPU and/or GPU 142, a memory 144, a communication interface 146 and an I/O device 148. The LLM server 140 hosts a Large Language Model. The LLM is an artificial intelligence model created using deep neural networks, mainly having a transformer architecture, that are pre-trained using self-supervised learning and semi-supervised learning to generate textual outputs based on learned patterns. Some examples of LLMs are GPT-3.5 and GPT-4 (Generative Pretrained Transformer 3.5/4) created by OpenAI, PaLM, T5 (Text-to-Text Transfer Transformer), BERT (Bidirectional Encoder Representations from Transformers) and Gemini created by Google, RoBERTa (Robustly Optimized BERT Approach) and LLAMA or LLAMA2 created by Meta, and Claude 2 created by Anthropic. These are simply a few examples of prominent LLMs. Any other suitable LLM may be used. One or more these LLMs may also be used for classification. For example, classification may be done using GPT-4 (or GPT-4 Turbo) or BERT. To clarify, the AI-generated comments are generated using an LLM (generative AI) whereas the comment-scoring classifier(s) may optionally be trained or fine-tuned using an LLM.

In the embodiment of FIG. 1, the LLM server 140 receives one or more prompts from the one or more tutoring platform servers (e.g. from backend services, a dedicated prompt-generating server or any other one or more of the servers that form part of the one or more tutoring platform servers) to cause the LLM to analyze the essay and to output AI-generated suggested written corrective feedback to the one or more tutoring platform servers 150, 160 and tutor computing device 104 for viewing by the human tutor to enable human-in-the-loop (HITL) review of the AI-generated suggested written corrective feedback by the human tutor. In other words, the LLM server 140 generates feedback on the essay and communicates this AI-generated feedback to the tutor computing device 104 for review by the human tutor 102. The tutor computing device 104 receives input from the human tutor 102 via a user interface to accept, reject or edit the AI-generated suggested written corrective feedback. The human-reviewed and/or human-modified AI-generated feedback thus constitutes HITL-AI written corrective feedback, i.e. AI-generated feedback that is refined by human-in-the-loop oversight or supervision. Optionally, the HITL-AI written corrective feedback may be supplemented by or include solely human comments from the human tutor. The tutor computing device 104, in response to a command or instruction from the human tutor 102 via the user interface, communicates the HITL-AI written corrective feedback to the one or more tutoring platform servers 150. The one or more tutoring platform servers then communicates the HITL-AI written corrective feedback to the student computing device 114 for viewing by the student 112. Optionally, the one or more tutoring platform servers 150 may review the HITL-AI written corrective feedback and may flag inadequate or inappropriate comments that the human tutor has added during his or her review. Optionally, the one or more tutoring platform servers 150 may communicate with the human tutor to request revision or modification of any inadequate or inappropriate comments made by the human tutor. Optionally, the one or more tutoring platform servers 150 may escalate the comments made by the first human tutor to a second human tutor (who may be a more senior or experienced tutor) for further review by the second human tutor.

In the embodiment depicted by way of example in FIG. 1, the one or more tutoring platform servers 150 may execute software (i.e. computer-readable instructions in machine-readable code) that performs the functions described above. The software may be stored in a computer-readable memory or other non-transitory computer-readable medium and executed by one or more processors of the one or more tutoring platform servers. Alternatively, the software may be executed by one or more processors of one or more computing devices, which may or may not include the one or more tutoring platform servers amongst other computers or servers. Accordingly, the software may in one embodiment be executed by one or more processors of one or more computing devices that are separate from and external to the one or more tutoring platform servers. Regardless of the structure or architecture of the system, the computer-executable instructions in code (defining the software) are executable by one or more processors of one or more computing devices to cause the one or more computing devices to assist a human tutor to assess an essay written by a student. The code causes one or more computing devices to receive the essay from the student and then interact with an LLM to elicit AI-generated feedback on the essay. Specifically, in one embodiment, the code causes the one or more computing devices (e.g. the one or more tutoring platform servers 150) to use (interact with) the Large Language Model (LLM) to request that the LLM analyze the essay and provide AI-generated suggested written corrective feedback on the essay. The code executed by the one or more processors causes the one or more computing devices to receive the AI-generated suggested written corrective feedback from the LLM and to then communicate it to the tutor computing device 104 so that the human tutor 102 can review it via a user interface of the tutor computing device 104. Thus, the human tutor provides a human-in-the-loop (HITL) review of the AI-generated suggested written corrective feedback. Specifically, the human tutor provides input via the user interface of the tutor computing device to accept, reject or edit (modify) the AI-generated suggested written corrective feedback. In one particular embodiment, this human-reviewed and human-modified AI-generated feedback may be supplemented with comments that are written solely (exclusively) by the human tutors. In this particular embodiment, the HITL-AI written corrective feedback may thus include one or more comments written solely by the human tutor, i.e. comments that originate from the human tutor as opposed to human-modified comments that originate from the LLM. In other words, the HITL-AI written corrective feedback may optionally include a mix of human-modified AI-generated feedback and comments that are written originally and solely by the human tutor. Finally, code executed by the one or more processors causes the one or more computing devices to communicate the HITL-AI written corrective feedback to the student. The code may be responsive to user input from the tutor via the user interface of the tutor computing device to trigger communication of the HITL-AI written corrective feedback to the student.

In one embodiment, the AI-generated suggested written corrective feedback is evaluated based on a plurality of rubric dimensions of a feedback rubric that represent desired feedback qualities. In other words, the feedback rubric defines the criteria for evaluating whether the feedback is good quality or not. In one specific embodiment, the plurality of rubric dimensions comprises a first rubric dimension evaluating whether the AI-generated suggested written corrective feedback is an encouraging comment, a second rubric dimension evaluating whether the AI-generated suggested written corrective feedback is an inquiry-based comment, and a third rubric dimension evaluating whether the AI-generated suggested written corrective feedback is a specific comment. In other embodiments, a different feedback rubric can be used which specify different rubric dimensions. In other words, in one specific embodiment, if feedback is encouraging, inquiry-based and specific, then it is considered valuable (good quality feedback) according to this particular feedback rubric. Alternatively, in other embodiments, the feedback may be evaluated based on more than these three rubric dimensions, as explained below, or evaluated globally in different ways to determine whether it is relevant and useful to be provided to the student. For example, in one specific embodiment, the assessment may require compliance with a majority of the rubric dimensions or any particular subset of the rubric dimensions.

For a comment to be considered encouraging, it must employ an encouraging, supportive and respectful tone. A comment with an encouraging tone recognizes the student's efforts before constructively addressing areas for improvement. Such a comment stimulates the student's motivation for revision, remains respectful to the student's efforts and struggles, and refrains from undermining the student.

For a comment to be considered inquiry-based, the key question is whether the comment uses inquiry-based questions to stimulate the student's thought on how to enhance or revise their work. A comment that meets this rubric will be contextualized and explain the rationale behind the question. It will demonstrate how addressing the comment will bolster the student's writing. It highlights errors or suggests improvements, articulates their nature, and provides guidance on rectification without offering a direct correction. The comment employs a blend of questions and reasoning to help students comprehend the feedback and its implementation.

For a comment to be considered specific, the comment must provide feedback that is specific to the student's work and goes beyond offering generic advice. A specific comment points out the exact text and idea being addressed.

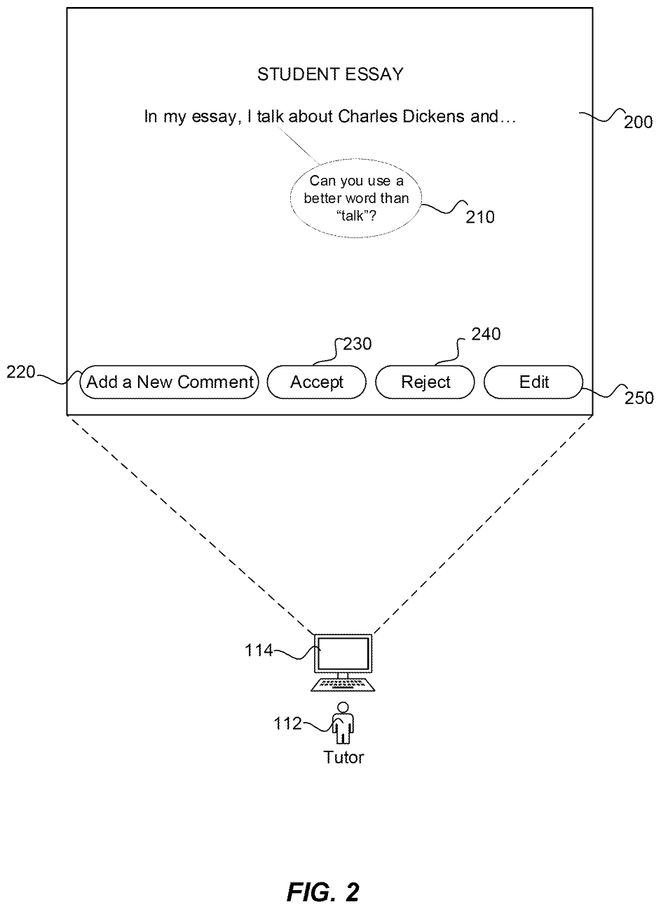

FIG. 2 depicts a simple example to illustrate the foregoing concept. In FIG. 2, a tutor 112 interacts with a tutor computing device 114 on which a student essay is displayed in whole or in part in an essay-viewing pane 200. The essay contains written text in the form of sentences and paragraphs, although the essay, given the broad definition introduced above, may be any other form of writing. The essay in this example is in English although this same concept can be applied to feedback in any other language as will be appreciated. The essay-viewing pane 200 also presents an AI-generated comment (i.e. AI-generated suggested written corrective feedback) 210. The AI-generated suggested written corrective feedback is scored (i.e. evaluated) for its adherence to the feedback rubric, i.e. each comment is scored based on its adherence to each of the rubric dimensions of the feedback rubric. This scoring is done automatically by a scoring server that is part of the one or more tutoring platform servers, or a specific comment-scoring module or classifier executed by the one or more tutoring platform servers. Comment scoring or classification is performed for two purposes: (1) model prompt development and (2) automated tutor performance measurement. AI-generated suggested written corrective feedback is scored in this example based on three rubric dimensions, i.e. whether it is encouraging, whether it is inquiry-based and whether it is specific. There may be fewer than three or more than three rubric dimensions in other embodiments. Likewise, it should be understood that in this particular embodiment, the rubric dimensions are encouraging, inquiry-based and specific but different rubric dimensions may be used in other embodiments. For example, a fourth rubric dimension may be suitability for student level. As another example, there may be eight rubric dimensions as follows: inquiry-based, encouraging, specific, suitable for student level, positive feedback only, safety and accuracy. In other words, in another implementations, there may be eight rubric dimensions as follows: the first, second and third rubric dimensions mentioned above supplemented by a fourth rubric dimension evaluating whether the AI-generated suggested written corrective feedback is suitable for a student level; a fifth rubric dimension evaluating whether the AI-generated suggested written corrective feedback is entirely positive; a sixth rubric dimension evaluating whether the AI-generated suggested written corrective feedback is unnecessarily repetitive by restating a same issue previously addressed; a seventh rubric dimension evaluating whether the AI-generated suggested written corrective feedback is unsafe; and an eighth rubric dimension evaluating whether the AI-generated suggested written corrective feedback is inaccurate.

In one embodiment, the one or more tutoring platform servers evaluates (scores) each of the comments generated by the LLM by applying a classifier implementing a classification model. The classifier has can be previously developed using a labeled dataset of comments that have been collected and labeled by human expert labelers to provide ground truth labels. In other words, development of the classifier can be done by evaluating the performance of the classifier on a labeled dataset of comments, e.g. using the human-labeled comments as a ground truth. In some embodiments, the classifier may use an LLM. In one embodiment, e.g. using BERT, the classifier is fine-tuned (further trained) on the dataset. In other embodiments, e.g. using GPT-based classifiers, it may not be necessary to fine-tune or further train the classifier although this may be optionally done. The dataset of comments used for training the classifier may optionally include both AI-generated comments and human-written comments. The classifier may optionally be fine-tuned on a labeled dataset of comments to further train an already develop (already pre-trained) models. Optionally, this may be useful particularly for a model like BERT which does not use natural language prompts and can benefit from alignment to labelled data.

The classifier evaluates (scores) the newly received comments generated by the LLM. The classifier may also evaluate (score) final human-modified comments. The classifier may also evaluate (score) solely human written comments. Comment scoring can be used in three key ways: (i) prompt development by measuring the quality of outputs for various prompts that are input to the LLM; (ii) tutor feedback by providing monthly scorecards to tutors and (iii) monitoring by observing a change in quality of AI outputs when there is data drift, i.e. a condition when the input data changes its properties, for instance when there is new group of students or new type of writing being fed to the model(s). To make sure that the data is up to standard, the performance is monitored by tracking these scores over time. Optionally, the tutor feedback is collected and presented to the tutor in a monthly scorecard for performance improvement.

In the example presented in FIG. 2, the comment is evaluated by the classifier as being not encouraging, i.e. the comment fails to meet the requisite level of encouragement to the student. Despite lacking an encouraging tone, the classifier nevertheless evaluates the comment as being sufficiently inquiry-based and also sufficiently specific. The human tutor can thus observe, in this example, the scores for each comment and revise the comment as needed. Optionally, the essay-viewing pane 200 may include user interface elements to add 220 a new comment, accept 230 the AI-generated comment 230, reject the AI-generated comment 240 or edit 250 the AI-generated comment. The visual layout presented by way of example in FIG. 2 is merely one example. Any other suitable layout or configuration of user interface elements, menu items, buttons, etc. may be used to enable the human tutor to accept, reject or revise the AI-generated comments.

Evaluation of comments (i.e. written constructive feedback) may be done by creating a classifier, e.g. a binary classifier, which scores the comments based on a ground truth dataset of human-labeled comments. In a variant, the classifier may be a multi-class classifier that classifies the comments into more than two classes. In this variant, the comment scoring may yield, for example, a numerical, quantitative or graded result or percentage indicative of the quality of the comment in terms of each rubric dimension. For example, a multi-class classifier may classify the comment into five tiers, assigning scores of 0%, 25%, 50%, 75% and 100% to the comment for each rubric dimension. Any other scoring technique may be utilized to achieve a similar outcome.

In one embodiment, the one or more tutoring platform servers may have a prompt-crafting module (or prompt-engineering module). The one or more tutoring platform servers may also have a prompt-tuning module. The scoring of the AI-generated comments may be used to craft or tune prompts for obtaining higher-quality AI-generated suggested written corrective feedback from the LLM. In other words, the one or more tutoring platform servers may learn by observing the prompts that provide AI-generated comments. The one or more tutoring platform servers may execute code to craft prompts based on classification results indicative of whether the comments adhere or not to the plurality of rubric dimensions.

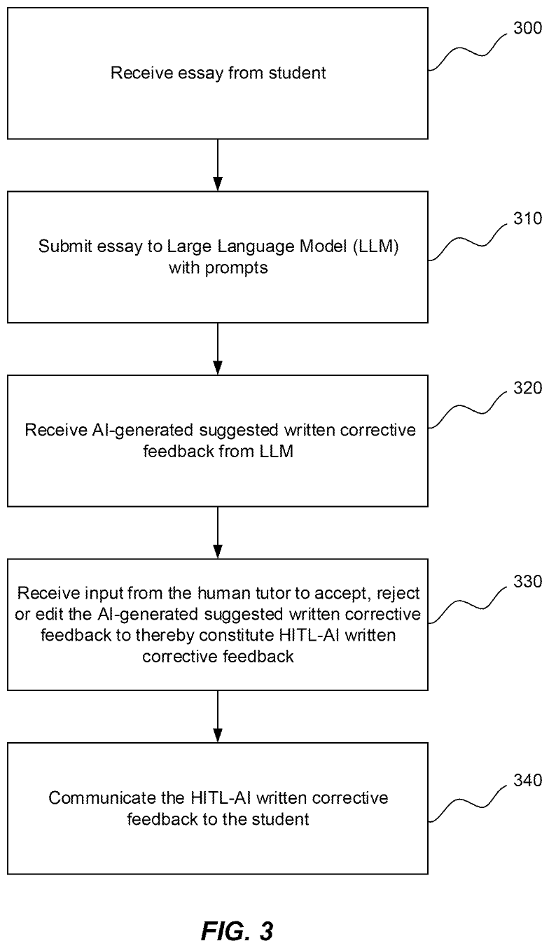

The foregoing system and computer-readable media furthermore enable a novel computer-implemented method of assisting a tutor in providing feedback to a student. In general, the method involves using AI-generated feedback from an LLM coupled with HITL review and oversight of the AI-generated feedback to provide a hybrid of human and AI feedback to the student. The computer-implemented method is depicted generally in the flowchart of FIG. 3. As depicted in FIG. 3, the computer-implemented method entails a step 300 of receiving an essay from a student. The method further involves a step 310 of submitting the essay to an LLM to elicit AI-generated comments on the essay. The method further entails a step 320 of receiving AI-generated suggested written corrective feedback from the LLM. At step 330 of the method, the human tutor (as human-in-the-loop) reviews the AI-generated suggested written corrective feedback from the LLM and accepts, rejects or edits the AI-generated suggested written corrective feedback. The HITL supervision of the AI-generated suggested written corrective feedback thus creates or constitutes HITL-AI written corrective feedback that has been found through experimentation to provide an innately human pedagogical expertise in terms of an educational domain-expert's qualitative analysis than the AI-generated suggested written corrective feedback can provide on its own. Finally, at step 340 of the method, the HITL-AI written corrective feedback is communicated to the student.

In one embodiment of the method, the AI-generated suggested written corrective feedback is evaluated based on a plurality of rubric dimensions of a feedback rubric. In one specific embodiment, the plurality of rubric dimensions includes a first rubric dimension evaluating whether the AI-generated suggested written corrective feedback is an encouraging comment, a second rubric dimension evaluating whether the AI-generated suggested written corrective feedback is an inquiry-based comment, and a third rubric dimension evaluating whether the AI-generated suggested written corrective feedback is a specific comment. As explained above, the AI-generated suggested written corrective feedback is evaluated or scored using a classifier.

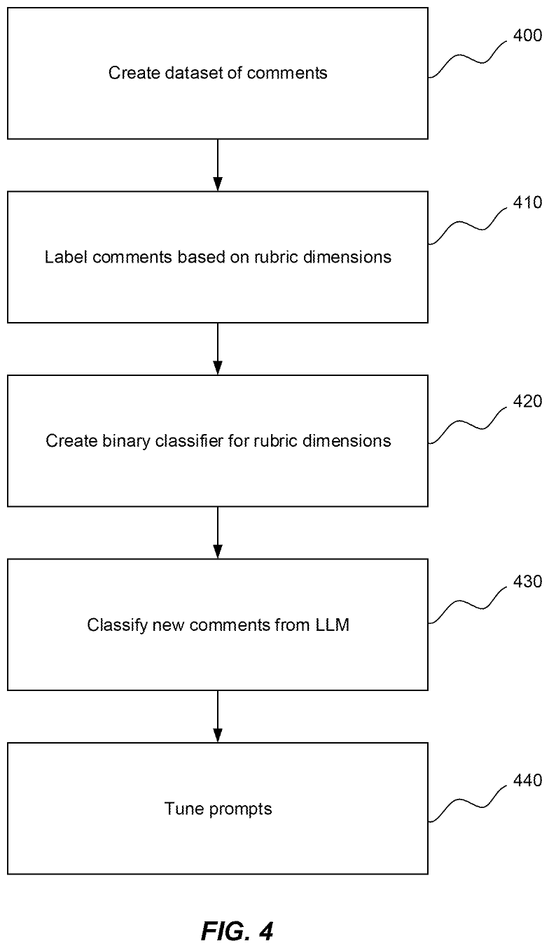

FIG. 4 is a flowchart depicting a method of training a classifier and then optionally tuning prompts. The method includes a step 400 of creating a dataset of comments, a step 410 of labeling the comments, by human expert reviewers, according to a plurality of rubric dimensions to create a labeled dataset and a step 420 of creating a binary classifier to classify new comments based on each one of the plurality of rubric dimensions. Once the classifier is created, the method can be used to perform a step 430 of classifying (evaluating or scoring) new AI-generated comments received from the LLM. Optionally, the method may be continued or extended by performing a further step 440 of tuning prompts based on the classification results from the classifier. The AI-generated suggested written corrective feedback provides efficiency and speed in correcting student essays. The HITL oversight significantly improves the overall quality of solely human-written comments while leveraging the agency and expertise of human, pedagogical experts. Optionally, the classifier can score/evaluate the AI-generated comments to help the tutor identify AI-generated comments that do not meet the rubric dimensions and which may require editing or even deletion. The classification results can be used by the one or more tutoring platform servers to reformulate or tune the prompts to enhance the quality of the AI-generated feedback that is elicited from the LLM.

In the foregoing embodiments, the one or more tutoring platform servers elicits AI-generated feedback on the essay from a single LLM. In another embodiment, the one or more tutoring platform servers may select one of a plurality of available LLMs from which to elicit AI-generated feedback on the essay. The selection may be made based on the language of the essay, the topic of the essay, the skill level of the student, the age of the student, etc. In a further embodiment, the one or more tutoring platform servers may elicit the AI-generated feedback from multiple LLMs. In such a scenario, the one or more tutoring platform servers may store and execute code that selects the best quality AI-generated feedback from the multiple LLMs. Alternatively, the one or more tutoring platform servers may pick and choose the best comments from all of the AI-generated feedback received from the multiple LLMs.

In the foregoing embodiments, the one or more tutoring platform servers trains its classifier based on a particular language. In another embodiment, the one or more tutoring platform servers trains language-specific classifiers and/or cultural-specific classifiers to classify feedback based on the nuances of language and/or culture. This helps to ensure that the comments are, for example, encouraging from a local linguistic and/or cultural perspective.

In the foregoing embodiments, the one or more tutoring platform servers obtains the AI-generated suggested written corrective feedback from an external LLM. In another embodiment, the LLM may be integrated with the one or more tutoring platform servers. In yet another embodiment, the LLM may be replaced by a specially-trained artificial neural network (AI model) that has been trained to provide feedback on essays. An automated essay annotation system having a specially trained neural network for annotating essays is disclosed in U.S. Pat. No. 10,957,212 entitled Cognitive Essay Annotation, which is hereby incorporated by reference. This automated essay annotation system having the specially trained neural network can be used, instead of the LLM, to generate suggested feedback (comments, annotations, corrections, etc.) for essays. The AI-generated feedback can be reviewed by a human tutor using the HITL technique described above in order to enhance the quality of the feedback. The AI-generated feedback can be scored using a classifier, as described above, to evaluate the quality of the feedback in terms of the rubric dimensions. Comment scoring is done in most instances, as described above, during prompt development or after the essay review is sent to the student.

These methods can be implemented in hardware, software, firmware or as any suitable combination thereof. That is, if implemented as software, the computer-readable medium comprises instructions in code which when loaded into memory and executed on a processor of a computing device causes the computing device to perform any of the foregoing method steps. These method steps may be implemented as software, i.e. as coded instructions stored on a computer readable medium which performs the foregoing steps when the computer readable medium is loaded into memory and executed by the microprocessor of the computing device. A computer readable medium can be any means that contain, store, communicate, propagate or transport the program for use by or in connection with the instruction execution system, apparatus or device. The computer-readable medium may be electronic, magnetic, optical, electromagnetic, infrared or any semiconductor system or device. For example, computer executable code to perform the methods disclosed herein may be tangibly recorded on a computer-readable medium including, but not limited to, a floppy-disk, a CD-ROM, a DVD, RAM, ROM, EPROM, Flash Memory or any suitable memory card, etc. The method may also be implemented in hardware. A hardware implementation might employ discrete logic circuits having logic gates for implementing logic functions on data signals, an application-specific integrated circuit (ASIC) having appropriate combinational logic gates, a programmable gate array (PGA), a field programmable gate array (FPGA), etc. For the purposes of this specification, the expression “module” is used expansively to mean any software, hardware, firmware, or combination thereof that performs a particular task, operation, function or a plurality of related tasks, operations or functions. When used in the context of software, the module may be a complete (standalone) piece of software, a software component, or a part of software having one or more routines or a subset of code that performs a discrete task, operation or function or a plurality or related tasks, operations or functions. Software modules have program code (machine-readable code) that may be stored in one or more memories on one or more discrete computing devices. The software modules may be executed by the same processor or by discrete processors of the same or different computing devices.

Computer readable program instructions can be downloaded to respective computing devices from a computer readable storage medium or to an external computer or external storage device via a data network, for example, the Internet, a local area network, a wide area network or a wireless network. The network may comprise copper transmission cables, optical transmission fibers, wireless transmission, routers, firewalls, switches, gateway computers and/or edge servers. A network adapter card or network interface controller (NIC) in each computing device receives computer readable program instructions from the network and transmits the computer readable program instructions for storage in a computer readable storage medium within the respective computing device.

Computer readable program instructions are computer-executable instructions in machine-readable code for carrying out operations of the present invention may be assembler instructions, instruction-set-architecture (ISA) instructions, machine instructions, microcode, firmware instructions, state-setting data, configuration data for integrated circuitry, or either source code or object code written in any combination of one or more programming languages, including an object oriented programming language and procedural programming languages. The computer-executable instructions executed by a computing device carry out program processes such as routines, programs, objects, components, logic, data structures that perform particular tasks or implement particular abstract data types.

Various aspects of the invention are described with reference to flowcharts and/or block diagrams of methods, systems, and computer program products. Each block of the flowcharts and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified by a block of the flowchart and/or block diagram.

The computer readable program instructions may also be loaded onto a computer, other programmable data processing apparatus, or other device to cause a series of operational steps to be performed on the computer, other programmable apparatus or other device to produce a computer implemented process or computer-implemented method, such that the instructions which execute on the computer, other programmable apparatus, or other device implement the functions/acts specified in the flowchart and/or block diagram.

The flowchart and block diagrams in the Figures illustrate the architecture, functionality, and operation of possible implementations of systems, methods, and computer program products according to various embodiments of the present invention. Each block in the flowchart or block diagrams may represent a module, segment, or portion of instructions, which comprises one or more executable instructions for implementing the specified function. In some alternative implementations, the functions noted in the blocks may occur out of the order shown in the Figures. For example, two blocks shown in succession may be executed substantially concurrently, or the blocks may sometimes be executed in the reverse order, depending upon the functionality involved. Each block of the block diagrams and/or flowcharts, and combinations of these blocks, can be implemented by special purpose hardware-based systems that perform the specified functions or acts or carry out combinations of special purpose hardware and computer instructions.

For the purposes of interpreting this specification, when referring to elements of various embodiments of the present invention, the articles “a”, “an”, “the” and “said” are intended to mean that there are one or more of the elements. The terms “comprising”, “including”, “having”, “entailing” and “involving”, and verb tense variants thereof, are intended to be inclusive and open-ended by which it is meant that there may be additional elements other than the listed elements.

This invention has been described in terms of specific implementations and configurations which are intended to be exemplary only. Persons of ordinary skill in the art will appreciate that many obvious variations, refinements and modifications may be made without departing from the inventive concepts presented in this application. The scope of the exclusive right sought by the Applicant(s) is therefore intended to be limited solely by the appended claims.

What is claimed is:

1. A non-transitory computer-readable medium storing code which when executed by one or more processors of one or more computing devices causes the one or more computing devices to assist a human tutor to assess an essay written by a student, the one or more processors being configured to:
analyze the essay using a Large Language Model (LLM) to output AI-generated suggested written corrective feedback to the human tutor via a user interface to enable human-in-the-loop (HITL) review of the AI-generated suggested written corrective feedback;
receive input from the human tutor via the user interface to accept, reject or edit the AI-generated suggested written corrective feedback to thereby constitute HITL-AI written corrective feedback; and
communicate the HITL-AI written corrective feedback to the student.

2. The non-transitory computer-readable medium of claim 1 wherein the AI-generated suggested written corrective feedback is evaluated based on a plurality of rubric dimensions of a feedback rubric that represent desired feedback qualities.

3. The non-transitory computer-readable medium of claim 2 wherein the plurality of rubric dimensions comprises:
a first rubric dimension to evaluate whether the AI-generated suggested written corrective feedback is an encouraging comment;
a second rubric dimension to evaluate whether the AI-generated suggested written corrective feedback is an inquiry-based comment; and
a third rubric dimension to evaluate whether the AI-generated suggested written corrective feedback is a specific comment.

4. The non-transitory computer-readable medium of claim 2 wherein the plurality of rubric dimensions comprises:
a first rubric dimension to evaluate whether the AI-generated suggested written corrective feedback is an encouraging comment;
a second rubric dimension to evaluate whether the AI-generated suggested written corrective feedback is an inquiry-based comment;
a third rubric dimension to evaluate whether the AI-generated suggested written corrective feedback is a specific comment;
a fourth rubric dimension to evaluate whether the AI-generated suggested written corrective feedback is suitable for a student level;
a fifth rubric dimension to evaluate whether the AI-generated suggested written corrective feedback is entirely positive;
a sixth rubric dimension to evaluate whether the AI-generated suggested written corrective feedback is unnecessarily repetitive by restating a same issue previously addressed;
a seventh rubric dimension to evaluate whether the AI-generated suggested written corrective feedback is unsafe; and
an eighth rubric dimension to evaluate whether the AI-generated suggested written corrective feedback is inaccurate.

5. The non-transitory computer-readable medium of claim 1 comprising code for crafting prompts to obtain the AI-generated suggested written corrective feedback from the LLM.

6. The non-transitory computer-readable medium of claim 1 comprising code that causes the one or more computing devices to evaluate the AI-generated suggested written corrective feedback, the one or more processor being configured to:
create a dataset of comments;
label the comments, by human expert reviewers, according to a plurality of rubric dimensions to create a labeled dataset; and
create a binary classifier to classify new comments based on each one of the plurality of rubric dimensions.

7. The non-transitory computer-readable medium of claim 6 wherein the dataset of comments includes both AI-generated comments and human-written comments.

8. The non-transitory computer-readable medium of claim 7 comprising code to craft prompts based on classification results indicative of whether the comments adhere or not to the plurality of rubric dimensions.

9. The non-transitory computer-readable medium of claim 8 wherein the plurality of rubric dimensions comprises:
a first rubric dimension to evaluate whether the AI-generated suggested written corrective feedback is an encouraging comment;
a second rubric dimension to evaluate whether the AI-generated suggested written corrective feedback is an inquiry-based comment; and
a third rubric dimension to evaluate whether the AI-generated suggested written corrective feedback is a specific comment.

10. The non-transitory computer-readable medium of claim 8 wherein the plurality of rubric dimensions comprises:
a first rubric dimension to evaluate whether the AI-generated suggested written corrective feedback is an encouraging comment;
a second rubric dimension to evaluate whether the AI-generated suggested written corrective feedback is an inquiry-based comment;
a third rubric dimension to evaluate whether the AI-generated suggested written corrective feedback is a specific comment;
a fourth rubric dimension to evaluate whether the AI-generated suggested written corrective feedback is suitable for a student level;
a fifth rubric dimension to evaluate whether the AI-generated suggested written corrective feedback is entirely positive;
a sixth rubric dimension to evaluate whether the AI-generated suggested written corrective feedback is unnecessarily repetitive by restating a same issue previously addressed;
a seventh rubric dimension to evaluate whether the AI-generated suggested written corrective feedback is unsafe; and
an eighth rubric dimension to evaluate whether the AI-generated suggested written corrective feedback is inaccurate.

11. A computer-implemented method of assisting a human tutor in tutoring a student in writing an essay, the method comprising:
analyzing the essay using a Large Language Model (LLM) to output AI-generated suggested written corrective feedback to the human tutor via a user interface to enable human-in-the-loop (HITL) review of the AI-generated suggested written corrective feedback;
receiving input from the human tutor via the user interface to accept, reject or edit the AI-generated suggested written corrective feedback to thereby constitute HITL-AI written corrective feedback; and
communicating the HITL-AI written corrective feedback to the student.

12. The method of claim 11 comprising evaluating the AI-generated suggested written corrective feedback based on a plurality of rubric dimensions of a feedback rubric.

13. The method of claim 12 wherein the plurality of rubric dimensions comprises:
a first rubric dimension evaluating whether the AI-generated suggested written corrective feedback is an encouraging comment;
a second rubric dimension evaluating whether the AI-generated suggested written corrective feedback is an inquiry-based comment; and
a third rubric dimension evaluating whether the AI-generated suggested written corrective feedback is a specific comment.

14. The method of claim 12 wherein the plurality of rubric dimensions comprises:
a first rubric dimension evaluating whether the AI-generated suggested written corrective feedback is an encouraging comment;
a second rubric dimension evaluating whether the AI-generated suggested written corrective feedback is an inquiry-based comment;
a third rubric dimension evaluating whether the AI-generated suggested written corrective feedback is a specific comment;
a fourth rubric dimension evaluating whether the AI-generated suggested written corrective feedback is suitable for a student level;
a fifth rubric dimension evaluating whether the AI-generated suggested written corrective feedback is entirely positive;
a sixth rubric dimension evaluating whether the AI-generated suggested written corrective feedback is unnecessarily repetitive by restating a same issue previously addressed;
a seventh rubric dimension evaluating whether the AI-generated suggested written corrective feedback is unsafe; and
an eighth rubric dimension evaluating whether the AI-generated suggested written corrective feedback is inaccurate.

15. The method of claim 11 comprising crafting one or more prompts for obtaining the AI-generated suggested written corrective feedback from the LLM.

16. The method of claim 11 comprising:
creating a dataset of comments;
labeling the comments, by human expert reviewers, according to a plurality of rubric dimensions to create a labeled dataset; and
creating a binary classifier to classify new comments based on each one of the plurality of rubric dimensions.

17. (canceled)

18. (canceled)

19. (canceled)

20. (canceled)

21. A computer system for assisting a human tutor to assess an essay written by a student, the system comprising:
a tutor computing device for the human tutor to view the essay;
one or more tutoring platform servers to receive the essay from the student and to transmit the essay to the tutor computing device;
a Large Language Model (LLM) server that hosts a Large Language Model, the LLM server being configured to receive one or more prompts from the one or more tutoring platform servers to cause the LLM to analyze the essay and to output AI-generated suggested written corrective feedback to the one or more tutoring platform servers and tutor computing device for viewing by the human tutor to enable human-in-the-loop (HITL) review of the AI-generated suggested written corrective feedback by the human tutor;
wherein the tutor computing device receives input from the human tutor to accept, reject or edit the AI-generated suggested written corrective feedback to thereby constitute HITL-AI written corrective feedback; and
wherein the tutor computing device communicates the HITL-AI written corrective feedback to the one or more tutoring platform servers and wherein the one or more tutoring platform servers communicates the HITL-AI written corrective feedback to the student.

22. The system of claim 21 wherein the one or more tutoring platform servers evaluates the AI-generated suggested written corrective feedback based on a plurality of rubric dimensions of a feedback rubric that represent desired feedback qualities.

23. (canceled)

24. (canceled)

25. The system of claim 21 wherein the one or more tutoring platform servers crafts prompts to obtain the AI-generated suggested written corrective feedback from the LLM.

26. The system of claim 21 wherein the one or more tutoring platform servers evaluates the AI-generated suggested written corrective feedback by configuring the one or more processors to:
create a dataset of comments;
label the comments, by human expert reviewers, according to a plurality of rubric dimensions to create a labeled dataset; and
create a binary classifier to classify new comments based on each one of the plurality of rubric dimensions.

27. (canceled)

28. (canceled)

29. (canceled)

30. (canceled)
